(19) United States
(12) Patent Application Publication
(10) Pub. No.: US 2025/0156794 A1
(43) Pub. Date: May 15, 2025

(54) SYSTEM AND METHOD FOR DELIVERY OF GOODS TO THE VEHICLE IN MOTION IN REAL TIME BY DRONE

(71) Applicant: Sava ZIVANOVIC, Belgrade (RS)

(72) Inventor: Sava ZIVANOVIC, Belgrade (RS)

(21) Appl. No.: 18/294,155

(22) PCT Filed: Jul. 22, 2022
(86) PCT No.: PCT/IB2022/056787

§ 371 Date: Jan. 31, 2024

(51) Int. Cl. G06Q 10/083; G05D 1/667; G05D 105/20; G05D 109/20; G06K 7/14; G06Q 20/10

(52) U.S. Cl. CPC G06Q 10/083; G05D 1/667; G06K 7/1417; G06Q 20/102; G05D 2105/20; G05D 2109/20

(57) ABSTRACT

A system for delivery of goods by a drone to a vehicle comprising at least one vehicle having a system of cameras and a communication display. The system further comprises a mobile smart device a QR code, a back-office server for data storage and execution of the payments, a retailer's server, a goods logistics base, a logistics base server and at least one drone. The vehicle may be any land vehicle, e.g. automobile, truck, bus, train composition, vessel (boat, ship), or aircraft (gas balloon, helicopter, airplane). Depending on the type of the goods and vehicle, the delivery of the said goods can be executed either directly to the vehicle in the motion, e.g., through the movable roof of the vehicle or at any particular platform on the vehicle.

### TECHNICAL FIELD

The present invention relates to a system and a method for delivery of goods by drone to a vehicle, particularly the vehicle in motion, in real time.

### Technical Problem

A technical problem solved by the present invention is how to order and pay goods, from the vehicle, which goods, in real time shall be delivered to the same vehicle in motion. The vehicle may in motion and at any given location.

### STATE OF THE ART

CA 3119810 (A1) discloses an elevated delivery platform having a delivery surface that can be placed at a location on the ground to better facilitate delivery of parcels, by unmanned aerial vehicles, such as delivery drones. By placing the elevated delivery platform in an area above the ground, such as a top of a home or a pole, the drone is more capable of making deliveries because it avoids obstacles nearer to the ground that typically make challenging the delivery by drone. The elevated delivery platform raises and lowers parcels to a position where they can easily be retrieved. Some systems also provide a deployable cover to protect parcels from adverse weather conditions while awaiting pickup or following delivery. The elevated delivery platform can be used as part of a drone delivery system that can also include a containment unit, a computer application, or any combination of these aspects.

WO 2018052334 (A1) discloses systems for delivering goods to collection points using drones. The system comprises drones, distribution centers (DC) 1, collection points (CP) 2, and a control center (CC) 3 containing a software. The invention provides the increase in speed of delivery of a container without the need for the user to install an individual landing platform for the drone.

WO 2017196190 (A1) discloses a secure parcel and mail delivery pod comprising an enclosure or housing configured to securely receive mail, parcels and the like. The pod and functions thereof are in electronic communication with delivery devices and can be remotely controlled by a user from a communication device, such as a smart telephone. The pod can be modular in design to accommodate different sized mail items, be visible and easily located by a delivery person, vehicle and/or autonomous delivery vehicle.

### SUMMARY OF THE INVENTION

The present application discloses a system and a method for delivery of goods by a drone to a vehicle, optionally in motion, in real time. The system comprises at least one vehicle 1 having a system of cameras 2 and a communication display 3. The system further comprises a user's smart mobile device 4 i.e. smartphone adapted for internet communication and which contains corresponding user's data, a QR code 5, a back-office server 6, which stores data and through which the payment is performed, a retailer's server 7, a logistics base 8 with the goods, a logistics base server 9 and at least one drone 10 at the logistics base 8.

The recording means, i.e. the system of cameras 2 of the vehicle 1 records the QR code 5, which may be placed on the billboard along the road being the route of the vehicle. The QR code 5 recording is shown on the communication display 3 from where it is transferred to the mobile smart device 4. There is a possibility also to record the QR code 5 directly by the mobile smart device 4, i.e. recording means, straight from the vehicle 1. In the mobile smart device 4 and the communication display 3 all relevant user's identification data is entered. Said data, along with the QR code 5 and the data included within the QR code 5 are forwarded to the back-office server 6, to be processed and confirmed, which is followed by the confirmation and identification of the user. The confirmation and identification of the user is then sent to the mobile smart device 4, and then further to the communication display 3.

The user, after the receipt of the confirmation through the communication display 3, or the mobile smart device 4, shall send the request to the retailer's server 7 for the delivery of the specific goods through the back-office server 6. The retailer's server 7 communicates to the logistics base server 9 at the logistics base 8 and submits the data related to the goods ordered by the user, as well as the data related to the location of the user, which data were received from the communication display 3 or the mobile smart device 4. The logistics base server 9 then sends the feedback about the availability and the price of the goods to the back-office server 6. This information is then forwarded through the back-office server 6 to the mobile smart device 4, and further uploaded to the communication display 3.

Thus, the payment is executed through the mobile smart device 4, or the communication display 3, and through the back-office server 6. The back-office server 6 provides the payment notification to the logistics base server 9 and the retailer's server 7. When the information regarding the ordered goods and the executed payment is received, the logistics base server 9 provides the delivery instruction for the ordered and paid goods, by means of the first available drone 10. Thus, the ordered goods are loaded to the first available drone 10. At the same time, the logistics base server 9 provides the drone 10 with all necessary data about the user and of the location of the vehicle, i.e. the location to which the goods shall be transferred.

### BRIEF DESCRIPTION OF DRAWINGS

FIG. 1 represents the block diagram of the system for delivery of goods by a drone to a vehicle in motion in real time.

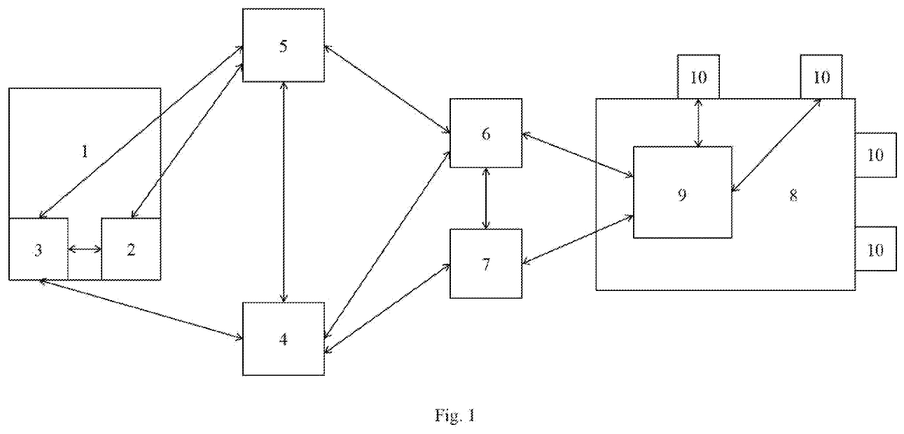

### DETAILED DESCRIPTION

A system for delivery of goods by a drone to a vehicle in real time comprises at least one vehicle 1 comprising a system of cameras 2 and a communication display 3. The system further includes a mobile smart device 4 i.e. smartphone adapted for internet communication and containing corresponding user's data. The smartphone may be placed within the vehicle.

The system further includes a QR code 5, a back-office server 6, which stores the data and through which the payment is performed, a retailer's server 7, a logistics base 8 with the goods, a logistics base server 9 and at least one drone 10 at the logistics base 8.

The vehicle 1 may be of any kind of land vehicle (e.g., motorcycle, automobile, truck, bus, train, military combat vehicle), a vessel (boat, ship, submarine), or an aircraft (gas balloon, dirigible, helicopter, airplane) which comprises the system of cameras 2, for safety purposes, and the communication display 3. The system of cameras 2, during the motion of the vehicle, records the route of the vehicle 1, and also the QR code 5 which may be placed on the billboard alongside of the road, alongside of the railway, airport runway, on the airplane gate approach or at the boat port entrance.

The system of cameras 2 of the moving vehicle 1 records the QR code 5. The QR code 5 recording is shown on the communication display 3 from where it is transferred to the mobile smart device 4 using internet network or Bluetooth. In one aspect, the QR code 5 may be recorded directly by the mobile smart device 4 placed within the vehicle 1, and then transferred to the communication display 3 using internet network or Bluetooth.

The mobile smart device 4 as well as the communication display 3 contain all relevant user's identification data. Said data, along with the QR code 5, or the corresponding data from the QR code 5, are forwarded to the back-office server 6 using internet network, to be processed and confirmed. The confirmation and identification of user is further sent to the mobile smart device 4, and further to the communication display 3. After the receipt of the confirmation and identification of user, the user sends the request to the retailer's server 7 for the delivery of the specific goods using the communication display 3 or the mobile smart device 4, through the back-office server 6.

The retailer's server 7, independently of its location, communicates via the internet network to the logistics base server 9 included in logistics base 8, and provides the data related to the ordered goods, and also the data related to the current location of the user. These data are obtained from the communication display 3 or the mobile smart device 4. Moreover, the logistics base server 9 sends the feedback about the availability and the price of the goods to the back-office server 6. This information is then transferred from the back-office server 6 to the mobile smart device 4, and then uploaded to the communication display 3.

Henceforth, the payment is executed using the mobile smart device 4, or the communication display 3, and through the back-office server 6.

The back-office server 6 provides the payment notification to the logistics base server 9 and the retailer's server 7 which stores the data of the purchase and of the executed payment. When the information regarding the ordered goods and the executed payment is received, the logistics base server 9 provides the delivery instruction for the ordered and paid goods, by means of the first available drone 10. The first available drone 10 must exhibit the sufficient loading capacity and flying radius.

Thus, ordered goods are loaded to the first available drone 10.

At the same time, the logistics base server 9 provides the drone 10 with all necessary data about the user and of the location of the vehicle, at the time of the order of the goods, the intended route of the vehicle and all other data, in order that the drone 10 would, by means of any global positioning system determine the exact location of the vehicle in the moment of the goods delivery i.e. the location to which the goods shall be transferred.

Upon the request of the user, or automatically, in the certain time intervals, the data related to the location of the vehicle 1 is transferred via the communication display 3 or the mobile smart device 4 to the back-office server 6, which then forwards the data to the logistics base server 9 and further to the specified drone 10 which executes the delivery of the ordered goods.

Thus, the method for delivery of goods according to the present invention comprises the following steps:
recording the QR code (5) by recording means (2, 4), i.e. the system of cameras (2) of the vehicle (1) or the mobile smart device (4),
transferring the QR code (5) and identification data of the user to the back-office server (6) for processing and confirming the data,
sending the confirmation and identification of user to the mobile smart device (4), and further to the communication display (3),
sending the order for the delivery of the goods by the user from the communication display (3) or the mobile smart device (4) to the retailer's server (7) though the back-office server (6),
communication of the retailer's server (7) with the logistics base server (9) at the logistics base (8) and submitting the data related to the goods ordered by the user of the system, and of the system user's location, received from the communication display (3) or the mobile smart device (4),
sending the feedback information, generated in the previous step, from the logistics base server (9) to the back-office server (6),
forwarding to the mobile smart device (4), and uploading the said information to the communication display (3),
executing payment of the ordered goods by the user using the mobile smart device (4) or the communication display (3) and through the back-office server (6),
sending the notification of the executed payment by the back-office server (6) to the logistics base server (9) and the retailer's server (7),
generating and sending a delivery instruction for the ordered and paid goods by the logistics base server (9) to the first available drone (10),
loading the goods to the first available drone (10),
providing the drone (10) with the location of the vehicle,
delivery of the goods to the vehicle.

In one aspect, the recording means (2, 4) is the system of cameras (2) of the vehicle (1). In this aspect, the method for delivery of goods includes the steps of:
displaying the QR code (5) received by the system of cameras (2) on the communication display (3),
transferring the QR code (5) from the communication display (3) to the mobile smart device (4), e.g. via the internet network or a Bluetooth, followed by forwarding the identification data of the user and the QR code (5) to the back-office server (6) for processing and confirming the received data.

In another aspect, the recording means (2, 4) is the mobile smart device (4). In this aspect, the method for delivery of goods includes transferring of the QR code to the communication display (3), e.g. via the internet network or a Bluetooth, followed by forwarding the identification data of the user and the QR code (5) to the back-office server (6) for processing and confirming the received data.

Depending on the type of the goods and the vehicle, the delivery of the said goods can be executed either directly to the vehicle 1 in motion (e.g., through the movable roof of the vehicle 1) or to any particular platform within the vehicle 1.

### INDUSTRIAL APPLICABILITY

The present invention may contribute to the logistics particularly in express delivery to any given location, and also in case of military needs or any significant natural disasters (earthquakes, wild fires, floods).

1. A system for delivery of goods to a vehicle by a drone comprising:
at least one vehicle (1) having a system of cameras (2) and a communication display (3),
a mobile smart device (4),
a QR code (5),
a back-office server (6) adapted for data storage and performing payments,
a retailer's server (7),
a logistics base (8),
a logistics base server (9) and
at least one drone (10),
wherein the communication display (3) and a mobile smart device (4) contain the identification data of the user.

2. The system for delivery of goods according to claim 1, wherein said vehicle is a land vehicle, a vessel, or an aircraft.

3. The system for delivery of goods according to any of the preceding claims, wherein the system of cameras (2) or the mobile smart device (4) is adapted to record the QR code (5).

4. The system for delivery of goods according to any of the preceding claims, further comprising a billboard comprising the QR code (5).

5. The system for delivery of goods according to any of the preceding claims, wherein the logistics base server (9) is adapted to provide the drone (10) with all necessary data about the user and the location of the vehicle, at the time of the order of the goods, the intended route of the vehicle and all other data.

6. A method for delivery of goods carried out by the system according to claims 1-5, characterized in that the method comprises the following steps:
recording the QR code (5) by recording means (2, 4),
transferring the QR code (5) and identification data of the user to the back-office server (6) for processing and confirming the data,
sending the confirmation and identification of user to the mobile smart device (4), and further to the communication display (3),
sending the order for the delivery of the goods by the user from the communication display (3) or the mobile smart device (4) to the retailer's server (7) though the back-office server (6),
communication of the retailer's server (7) with the logistics base server (9) at the logistics base (8) and submitting the data related to the goods ordered by the user of the system, and of the system user's location, received from the communication display (3) or the mobile smart device (4),
sending the feedback information, generated in the previous step, from the logistics base server (9) to the back-office server (6),
forwarding to the mobile smart device (4), and uploading the said information to the communication display (3),
executing payment of the ordered goods by the user using the mobile smart device (4), or the communication display (3), and through the back-office server (6),
sending the notification of the executed payment by the back-office server (6) to the logistics base server (9) and the retailer's server (7),
generating and sending a delivery instruction for the ordered and paid goods by the logistics base server (9) to the first available drone (10),
loading the goods to the first available drone (10),
providing the drone (10) with the location of the vehicle,
delivery of the goods to the vehicle.

7. The method for delivery of goods according to claim 6,
wherein the recording means (2, 4) is the system of cameras (2) of the vehicle (1) or the mobile smart device (4).

8. The method for delivery of goods according to claim 7, wherein the recording means (2, 4) is the system of cameras (2) of the vehicle (1).

9. The method for delivery of goods according to claim 8, wherein the step of recording the QR code (5) by the system of cameras (2) of the vehicle (1) is followed by the following steps:
displaying the QR code (5) on the communication display (3) received by the system of cameras (2),
transferring the QR code (5) from the communication display (3) to the mobile smart device (4) via the internet network or a Bluetooth followed by forwarding the identification data of the user and the QR code (5) to the back-office server (6) for processing and confirming the received data.

10. The method for delivery of goods according to claim 7, wherein the recording means (2, 4) is the mobile smart device (4).

11. The method for delivery of goods according to claim 10, wherein the step of recording the QR code (5) by mobile smart device (4) is followed by:
transferring of the QR code to the communication display (3) via the internet network or a Bluetooth followed by forwarding the identification data of the user and the QR code (5) to the back-office server (6) for processing and confirming the received data.
